(19) United States
(12) Patent Application Publication
(10) Pub. No.: US 2003/0220130 A1
(43) Pub. Date: Nov. 27, 2003

(54) Apparatus for transmitting and/or receiving data, tire for a motor vehicle, transmitting and/or receiving device and system for the wireless transmission of data

(76) Inventors: Michael Munz, Reutlingen (DE); Hubert Benzel, Pliezhausen (DE); Heinz-Georg Vossenberg, Pfullingen (DE); Regina Grote, Reutlingen (DE)

Correspondence Address: KENYON & KENYON, ONE BROADWAY, NEW YORK, NY, 10004, US

(21) Appl. No.: 10/321,135

(22) Filed: Dec. 17, 2002

(30) Foreign Application Priority Data
Dec. 29, 2001 (DE) 101 64 489.2

(51) Int. Cl. H04B 1/40

(52) U.S. Cl. 455/575.7; 455/562.1; 455/74

(57) ABSTRACT

An apparatus, a tire, a transmitting and/or receiving device and a system for the wireless transmission of data between the apparatus and the transmitting and/or receiving device are provided, an antenna being frictionally connected to a rotating part, the antenna being provided in a manner that it projects from the part.

### FIELD OF THE INVENTION

The present invention is directed toward an apparatus, a tire, a transmitting and/or receiving device and a system for the wireless transmission of data.

### BACKGROUND INFORMATION

German Patent No. 197 02 768 describes an apparatus for the wireless transmission of at least one measured value from moving parts. However, in this related art it is necessary to carry out a multiple, bi-directional data transmission for transmitting a single measured value. Furthermore, the radio connection between the tire and the vehicle is poor, since a connection is only possible at specific positions of the tire.

### SUMMARY OF THE INVENTION

The apparatus of the present invention, the tire of the present invention, the transmitting and/or receiving device of the present invention and the system of the present invention for the wireless transmission of data have the advantage that transmitting and receiving antennas for the tire-condition system do not have to be implemented on a printed circuit board, but rather may be implemented by an external antenna of the apparatus. The use of the metallic valve portion or of parts thereof is advantageously suitable for this purpose. It is thereby advantageously possible to guarantee a better and more reliable communication between the tire-condition system and the vehicle. This especially offers the advantage of flexibility in the frequency selection, and it is possible to achieve improvement in the communication and in cost reduction.

Moreover, it is advantageous that the part includes a valve, and that at least a part of the valve is provided as an antenna. According to the invention, metals which are present in the tire and which can impair the communication between the apparatus and the vehicle thereby do not lead or lead only to a slight degree to a disturbance of the communication between the apparatus and the vehicle. The use of an external antenna, particularly the use of the valve, i.e. of parts of the valve, of the tire of the vehicle expands the available frequency spectrum and improves the communication quality. This is especially the case when the communication between the tire-condition system, i.e. the apparatus in the tire, and the appertaining control unit in the vehicle takes place by high-frequency, electromagnetic radiation. Furthermore, according to the invention, it is possible on the printed circuit board provided for the apparatus of the present invention, to save that printed circuit board surface which, particularly when the antenna is implemented as a coil form or in the form of an antenna printed circuit trace, would have been used on the printed circuit board for the antenna. In this context, to be understood by the term printed circuit board is any substrate such as, for example, a ceramic substrate or the like, as well. A cost reduction can be expected by omitting this additional surface. Furthermore, according to the invention, the frequency spectrum available may advantageously be expanded by the use of an external antenna, i.e., particularly by the use of at least a part of the valve as antenna. Moreover, according to the invention, by the use of an external antenna, i.e., by the use of the valve as an external antenna, it is possible to reduce the transmission power, and thereby to reduce the current consumption of the apparatus according to the present invention. This is so because at the location of the antenna, provided in a manner that it projects from the tire, i.e., in the case of the external antenna, no or only a slight shielding occurs, particularly due to metal parts in the tire (Faraday shield). The energy demand of the system is thereby markedly reduced, and the service life of the system is increased if a constant energy capacity is provided, for example, in the form of an installed battery. Alternatively—in the event no installed battery, but rather a chargeable energy source is provided—the costs and outlay for making the re-chargeable energy source available are thereby reduced, because its performance requirements may be reduced by the lower transmission power of the external antenna.

In addition, it is particularly advantageous that the part is a tire of a vehicle. It is thereby possible to provide the present invention in particular for motor vehicles, and thus to contribute to increasing safety of operation of the motor vehicle.

### BRIEF DESCRIPTION OF THE DRAWINGS

FIG. 1 shows a separate system of an external antenna and an apparatus according to the present invention.

FIG. 2 shows a combined system of external antenna and apparatus according to the present invention.

FIG. 3 shows a tire and a vehicle with associated components.

### DETAILED DESCRIPTION

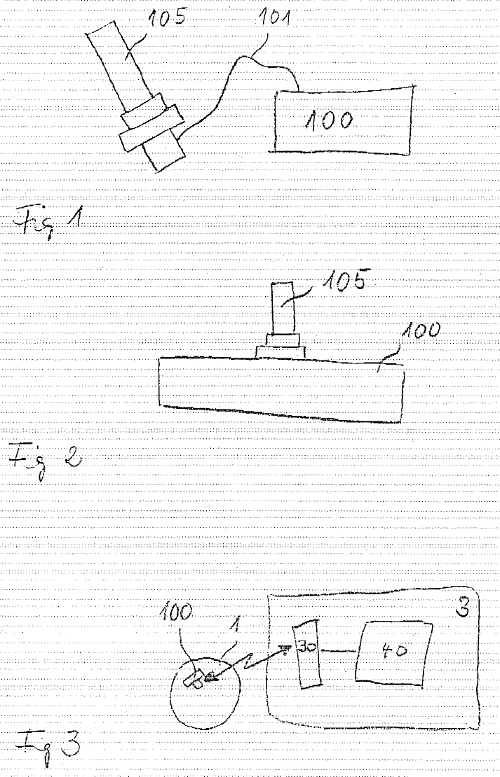

FIG. 1 shows an apparatus 100 of the present invention which is connected to an external antenna 105 via an electrical connection 101. Apparatus 100 of the present invention is also designated in the following as tire-condition measuring system 100. In the present invention, external antenna 105 is in particular the valve of a tire of a motor vehicle. However, both the tire and the motor vehicle are not yet shown in FIGS. 1 and 2. According to the invention, antenna 105 may also be provided in such a way that it includes only a part of the valve, in particular, the invention provides that in this case, it is the metallic part of the valve. Moreover, the present invention provides that the valve is used as the support of an antenna unit allocated to the valve, which is made, for example, of plastic.

FIG. 2 shows apparatus 100 of the present invention and external antenna 105 in a combined specific embodiment made of antenna 105 and apparatus 100. Thus, in contrast to FIG. 1, here antenna 105 is not connected to apparatus 100 via an electrical connection 101, but rather external antenna 105 is fixedly joined to apparatus 100. When working with the embodiment in FIG. 2, according to the invention, apparatus 100 of the present invention is provided in particular in the lower part of the valve of a tire, so that apparatus 100 is localized in the inner area of the torus formed by the cladding of the tire, and the valve, i.e. antenna 105, projects at least from the tire. According to the invention, this has the particular advantage that it is not necessary to change existing constructions of valves on tires, since such valves are provided at least partially externally to the tire in any case, that is to say, are provided in such a way that the valve projects at least partially from the tire.

FIG. 3 shows the tire, which in FIG. 3 is provided with the reference numeral 1, and the vehicle, which in FIG. 3 is provided with the reference numeral 3. Tire 1 includes apparatus 100 of the present invention, the external antenna in FIG. 3 only being alluded to in apparatus 100 of the present invention, and not being provided with a reference numeral. Moreover, vehicle 3 according to FIG. 3 includes a transmitting and/or receiving device 30 and a control unit 40. Transmitting and/or receiving device 30 and control unit 40 are interconnected. According to the present invention, a wireless data transmission, which is depicted in FIG. 3 by a double-bent arrow, but without reference numeral, is provided between transmitting and/or receiving device 30 and apparatus 100, that is to say, particularly the antenna of apparatus 100.

An essential factor for increasing safety in road traffic is the reduction of the braking distance, as well as supporting interventions in the traction control system and other systems used for driving safety. In this context, important information is data which is present only in the tire of a motor vehicle, such as the tire pressure, the tire temperature, the type of tire, the number of kilometers driven with this tire and further data. According to the invention, the indicated information is made available to vehicle 3 with the aid of the wireless transmission from tire 1. To that end, apparatus 100 of the present invention is provided, which is therefore also designated as tire-condition measuring system 100. Apparatus 100 includes in particular a printed circuit board which, however, is not shown in the figures, on which electronic circuits are located for controlling the apparatus of the present invention. The system of the present invention for the wireless transmission includes the components shown in FIG. 3, particularly apparatus 100 according to the invention in tire 1, and transmitting and/or receiving device 30 in vehicle 3. According to the invention, also to be added to the system of the present invention is—if existing—control unit 40 in vehicle 3.

What is claimed is:

1. An apparatus for at least one of transmitting and receiving data, comprising:
a device connected to a rotating part; and
an antenna frictionally connected to the rotating part, the antenna projecting from the rotating part.

2. The apparatus according to claim 1, wherein the part includes a valve, at least a part of the valve being provided as the antenna.

3. The apparatus according to claim 1, wherein the part is a tire of a vehicle.

4. A tire for a vehicle comprising:
a device connected to the tire; and
an antenna frictionally connected to the tire, the antenna projecting from the tire.

5. A transmitting/receiving device comprising:
a device adapted to cooperate with an apparatus, the apparatus including an arrangement connected to a rotating part, the apparatus further including an antenna frictionally connected to the rotating part and projecting from the rotating part.

6. A system for the wireless transmission of data, comprising:
an apparatus including a device connected to a rotating part, the apparatus further including an antenna frictionally connected to the rotating part, the antenna projecting from the rotating part; and
a transmitting/receiving device for at least one of transmitting and receiving data, the transmitting/receiving device and the apparatus being in wireless communication with one another.
